(19) United States
(12) Patent Application Publication
(10) Pub. No.: US 2022/0140552 A1
(43) Pub. Date: May 5, 2022

(54) WIRE-TO-WIRE CONNECTOR

(71) Applicant: KYOCERA AVX Components Corporation, Fountain Inn, SC (US)

(72) Inventor: Xin Jin, Fountain Inn, SC (US)

(21) Appl. No.: 17/518,082

(22) Filed: Nov. 3, 2021

(30) Foreign Application Priority Data
Nov. 5, 2020 (CN) PCT/CN2020/126711

(51) Int. Cl. H01R 31/00; H01R 13/64; H01R 13/52

(52) U.S. Cl. CPC H01R 31/00; H01R 13/5205; H01R 13/64

(57) ABSTRACT

An electrical connector includes a housing having a first opening to receive a first wire and a second opening to receive a second wire, a first contact within a volume of the housing to electrically connect the first wire to the second wire, such that the first contact includes a first contact tine and a second contact tine, and a second contact within the volume of the housing to electrically connect the first wire to the second wire, such that the second contact includes a third contact tine and a fourth contact tine. The first contact tine is biased towards the third contact tine to receive the first wire and the second contact tine is biased towards the fourth contact tine to receive the second wire.

### CROSS REFERENCE TO RELATED APPLICATIONS

The present application claims priority to PCT/CN2020/126711, filed on Nov. 5, 2020, the contents of which are incorporated by reference herein in their entirety.

### FIELD

The present application relates generally to the field of electrical connectors, and more particularly to a type of connector used to electrically connect one wire to another wire.

### BACKGROUND

The following description is provided to assist the understanding of the reader. None of the information provided or references cited are admitted to be prior art.

Various types of connectors are used for forming electrical connections between a wire and any manner of electronic or electrical component. These connectors are typically available as sockets, plugs, and shrouded headers in a vast range of sizes, pitches, and plating options. Traditionally, for two wires to be connected together, a user must strip the first and second wires, twist the two ends together, and then secure them to one other. This process can be tedious, inefficient, and undesirable. Furthermore, a wire-to-wire connection that may fall apart or short out unexpectedly could be hazardous or even deadly. Thus, a quick, efficient, and reliable means of connecting and disconnecting wires is needed.

### SUMMARY

The systems, methods and devices of this disclosure each have several innovative aspects, no single one of which is solely responsible for the desirable attributes disclosed herein.

In accordance with some embodiments of the present disclosure, an electrical connector is disclosed. The electrical connector includes a housing having a first opening to receive a first wire and a second opening to receive a second wire, a first contact within a volume defined by the housing to electrically connect the first wire to the second wire such that the first contact includes a first contact tine and a second contact tine, and a second contact within the volume defined by the housing to electrically connect the first wire to the second wire. The second contact includes a third contact tine and a fourth contact tine. The first contact tine is biased towards the third contact tine to receive the first wire and the second contact tine is biased towards the fourth contact tine to receive the second wire.

In accordance with some embodiments of the present disclosure, another electrical connector is disclosed. The electrical connector includes a housing having a first opening to receive a first wire and a second opening to receive a second wire, a contact within a volume defined by the housing to electrically connect the first wire to the second wire, a first receiving portion on a first sidewall of the housing, and a first peg on the first sidewall of the housing. The first receiving portion and the first peg are configured to removably connect the electrical connector to a second electrical connector.

In accordance with some embodiments of the present disclosure, a method is disclosed. The method includes inserting a first wire through a first opening defined in a housing of an electrical connector such that upon inserting, the first wire contacts a first portion of a first contact and a first portion of a second contact within a volume defined by the housing. The method also includes inserting a second wire through a second opening defined in the housing, such that upon insertion, the second wire contacts a second portion of the first contact and a second portion of the second contact within the volume for electrically connecting the first wire to the second wire. The method additionally includes connecting the electrical connector to a second electrical connector, such that the electrical connector comprises a first receiving portion and a first peg on the housing of the electrical connector and the second electrical connector includes a second receiving portion and a second peg on the housing of the second electrical connector, and connecting the electrical connector to the second electrical connector includes receiving the first peg within the second receiving portion and receiving the second peg within the first receiving portion.

### BRIEF DESCRIPTION OF THE DRAWINGS

FIG. 1 is a perspective view of an electrical connector having a first wire and a second wire inserted therein, in accordance with some embodiments of the present disclosure.

FIGS. 2A and 2B are perspective views of the electrical connector of FIG. 1 without the plurality of wires inserted therein, in accordance with some embodiments of the present disclosure.

FIG. 2C is an exploded view of the electrical connector of FIGS. 2A and 2B, in accordance with some embodiments of the present disclosure.

FIG. 3A is a partially exploded view of the electrical connector of FIGS. 2A and 2B, in accordance with some embodiments of the present disclosure.

FIG. 3B is a cross-sectional view taken along lines A-A of FIG. 3A, in accordance with some embodiments of the present disclosure.

FIG. 4A is a top view of the electrical connector of FIGS. 2A and 2B with a cover portion of the electrical connector removed, in accordance with some embodiments of the present disclosure.

FIG. 4B is a cross-sectional view taken along lines E-E of FIG. 4A without the first wire and the second wire inserted into the electrical connector, in accordance with some embodiments of the present disclosure.

FIG. 4C is another cross-sectional view taken along lines E-E of FIG. 4A with the first wire and the second wire inserted into the electrical connector, in accordance with some embodiments of the present disclosure

FIG. 5 is an example showing a mechanism to removably connect multiple electrical connectors with each other, in accordance with some embodiments of the present disclosure.

FIG. 6 is an example flowchart outlining operations for manufacturing/assembling the electrical connector of FIG. 1, in accordance with some embodiments of the present disclosure.

FIG. 7 is an example flowchart outlining operations for using the electrical connector of FIG. 1, in accordance with some embodiments of the present disclosure.

### DETAILED DESCRIPTION

Reference will now be made to various embodiments, one or more examples of which are illustrated in the figures. The embodiments are provided by way of explanation of the invention, and are not meant as a limitation of the invention. For example, features illustrated or described as part of one embodiment may be used with another embodiment to yield still a further embodiment. It is intended that the present application encompass these and other modifications and variations as come within the scope and spirit of the invention.

Disclosed herein is a wire-to-wire connector that includes a housing and a pair of contacts. The pair of contacts may be used to electrically connect multiple wires. Specifically, the pair of contacts provide a current carrying capability to efficiently and reliably mechanically and electrically couple the multiple wires to each other via a single one-piece connector. The pair of contacts provide additional rigidity and mechanical robustness to the connection between the multiple wires by using a unique contact tine configuration. Further, the pair of contacts provide multiple points of electrical contact to the wires, thereby increasing the current flow between the wires. Thus, the wire-to-wire connector allows for efficient and rapid creation of an electrical and mechanical connection between conductive portions of the wires without soldering or crimping the wires. Furthermore, the unique design of the contact allows for the contact to be constructed out of a single piece of conductive material. This construction minimizes the number of components that must be manufactured and connected to one another to form the contact, and thus simplifies the manufacturing process.

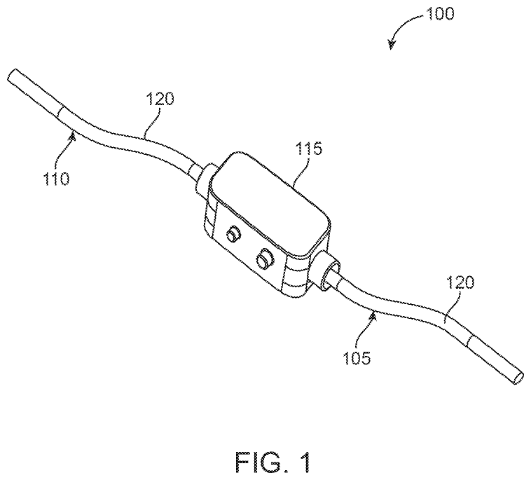

Referring to FIG. 1, a perspective view of an example electrical connector 100 is shown, in accordance with some embodiments of the present disclosure. The electrical connector 100 is a wire-to-wire connector that is configured to electrically connect a first wire 105 to a second wire 110 via an electrically conductive contact disposed within a housing 115. The housing 115 of the electrical connector 100 may be formed from any suitable non-conductive material (e.g., plastic, silicone, etc.). The shape and size of the housing 115 may vary based upon the shape and size of the contact therein, as well as the types of wires that are to be connected. Although the electrical connector 100 is shown to connect two wires (e.g., the first wire 105 and the second wire 110), in some embodiments, the electrical connector may be used to connect greater than two wires. In some embodiments, the first wire 105 and the second wire 110 may each be similarly shaped and sized, while in other embodiments, either of those wires may have different shapes and/or sizes.

Further, the first wire 105 and the second wire 110 may each include an outer insulative layer 120 and conductive core or strands therein (not shown). In some embodiments, an end portion of the outer insulative layer 120 of the first wire 105 and the second wire 110 may be removed to expose the conductive core or strands, and the conductive core or strands may be inserted into the housing 115 for electrically connecting the first wire to the second wire. As a result of stripping the outer insulative layer 120 to expose the conductive core or strands of the first wire 105 and the second wire 110 and inserting the exposed conductive core or strands into the housing 115, the conductive core or strands of those wires are pressed against or otherwise contact the conductive walls of the contact within the housing for creating an electrical connection between those wires. In some embodiments, the entirety of the portions of the first wire 105 and the second wire 110 that extend outwardly from the housing 115 may not be stripped of their outer insulative layers (e.g., the outer insulative layer 120) to minimize safety concerns from the exposed conductive cores. In some embodiments, a conductive insertion portion, partially or wholly encompassed by the housing 115, may be used into which the conductive core or strands of the first wire 105 and the second wire 110 may be inserted.

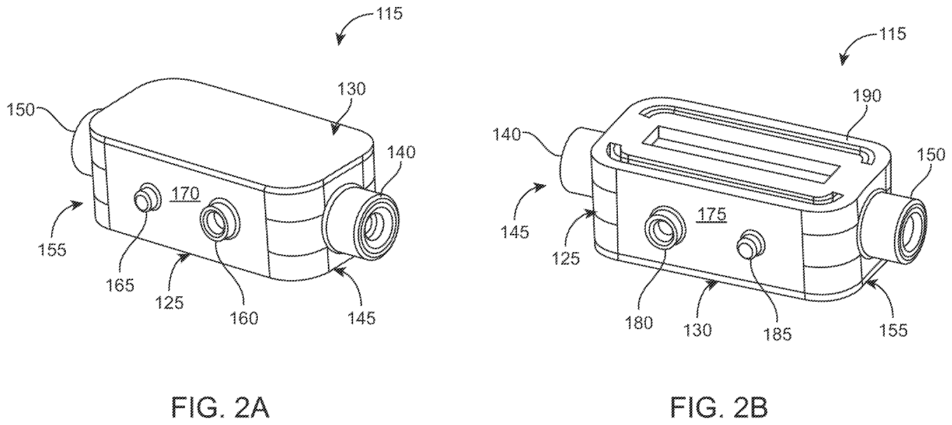

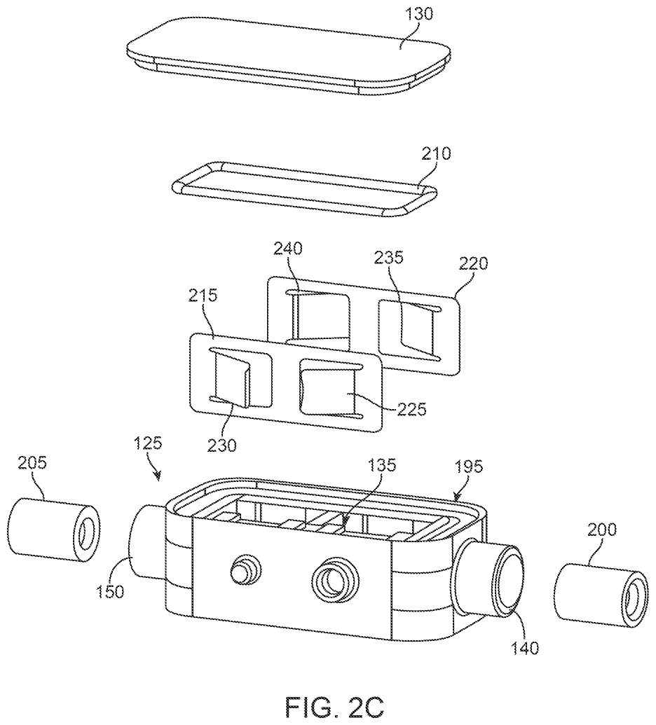

Turning now to FIGS. 2A-2C, additional views of the electrical connector 100 are shown without the first wire 105 and the second wire 110 inserted therein. FIGS. 2A and 2B show perspective views of the electrical connector 100, while FIG. 2C shows an exploded view of the electrical connector. The housing 115 of the electrical connector 100 may include a base portion 125 and a cover portion 130. In some embodiments, both the base portion 125 and the cover portion 130 may be constructed from an electrically-insulative material (e.g., plastic, silicone, etc.). In some embodiments, the base portion 125 and the cover portion 130 may be constructed from the same material, while in other embodiments, the base portion and the cover portion may be constructed from different materials. The base portion 125 may be interlocked with the cover portion 130, as described below, to define a volume 135 (see FIG. 2C) within the base portion within which a pair of electrically conductive contacts may be disposed.

Although the base portion 125 and the cover portion 130 are shown rectangular in shape with curved corners, in other embodiments, the base portion may assume other shapes and configurations. The cover portion 130 may be shaped and configured according to the shape and configuration of the base portion 125 to interlock with the base portion. Similarly, in some embodiments, the size (e.g., length, width, and/or thickness) of the base portion 125 and the cover portion 130 may vary from that shown.

Further, the base portion 125 defines a first projection 140 defining an opening at a first end 145 of the housing 115 to receive the first wire 105 and a second projection 150 defining an opening at a second end 155 of the housing to receive the second wire 110. The openings in each of the first projection 140 and the second projection 150 may be sized and shaped according to the size and shape of the wire that is to be inserted through those openings. Thus, in some embodiments, to connect two wires that are similarly shaped and sized, the openings of the first projection 140 and the second projection 150 may be shaped and sized similar to one another. In other embodiments, to connect two wires that are different shaped and/or sized, the openings of the first projection 140 and the second projection 150 may be shaped and/or sized differently depending upon the shape and/or size of the wire that the respective opening is to receive. Further, although two wire receiving openings (e.g., the opening in the first projection 140, the opening in the second projection 150) are shown herein to receive two wires (e.g., the first wire 105, the second wire 110), in other embodiments, greater or fewer number of projections defining greater or fewer number of openings may be provided based upon the number of wires that are to be connected within the electrical connector 100. In some embodiments, instead of protruding out of the housing 115, the first projection 140 and/or the second projection 150 may be encompassed within the housing.

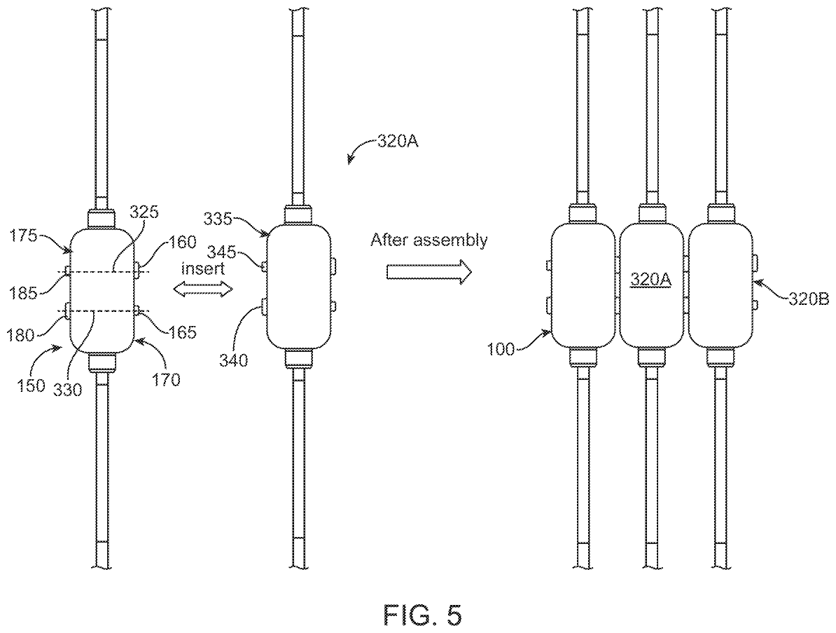

In addition to the first projection 140 and the second projection 150, in some embodiments, the base portion 125 also defines a receiving portion 160 and a peg 165 extending outwardly or protruding from a side wall 170 of the base portion. The side wall 170 extends between the first end 145 and the second end 155 of the base portion 125. Similarly, in some embodiments, side wall 175 may have a receiving portion 180 and a peg 185 extending outwardly therefrom. For example, the receiving portion 180 may include a cylindrical portion extending from an outer surface of side wall 175 and having an open volume within the cylindrical portion to receive a corresponding peg. The side wall 175 may be opposite to the side wall 170 and may extend between the first end 145 and the second end 155. The receiving portions 160 and 180, as well as the pegs 165 and 185 may be used to connect the electrical connector 100 to other electrical connectors, as shown in FIG. 5 below. Although one receiving portion (e.g., the receiving portions 160, 180) and one peg (e.g., the pegs 165, 185) is shown on each of the side walls 170, 175, in other embodiments, more than one receiving portions and/or more than one pegs may be provided on either side wall. Further, in some embodiments, instead of providing receiving portions and pegs on both side walls, in some embodiments, receiving portions and pegs may be provided on only one side wall. In some embodiments, instead of providing both receiving portions and pegs on a side wall, each side wall may have either one or more receiving portions or one or more pegs. Additionally, in some embodiments, depending upon how (e.g., the orientation, direction) the electrical connector 100 is to be connected to other electrical connectors, receiving portions and/or pegs may be provided on other surfaces of the base portion 125. In some embodiments, one or more receiving portions and/or pegs may be provided on the cover portion 130.

Further, the shape and size of the receiving portions 160 and 180, as well as the pegs 165 and 185 may vary from one embodiment to another. For example and as shown in FIGS. 2A and 2B, in some embodiments, the pegs 165 and 185 may be smaller in size than the receiving portions 160 and 180, respectively. In some embodiments, the receiving portions 160 and 180 may be configured with openings or recesses that are configured to receive the pegs 165 and 185 of another electrical connector to connect two electrical connectors together. Further, in some embodiments, the depth of the openings of the receiving portions 160 and 180 may be configured to correspond with the width of the pegs 165 and 185 that is protruding from the surface of the side walls 170, 175. Thus, the receiving portions 160 and 180 may be shaped and sized to receive the pegs 165 and 185 therein. Although the receiving portions 160 and 180, as well as the pegs 165 and 185 are shown to be cylindrical in shape, in other embodiments, corresponding pairs (e.g., a pair of a receiving portion and a peg that is to be received within the receiving portion) may assume other shapes.

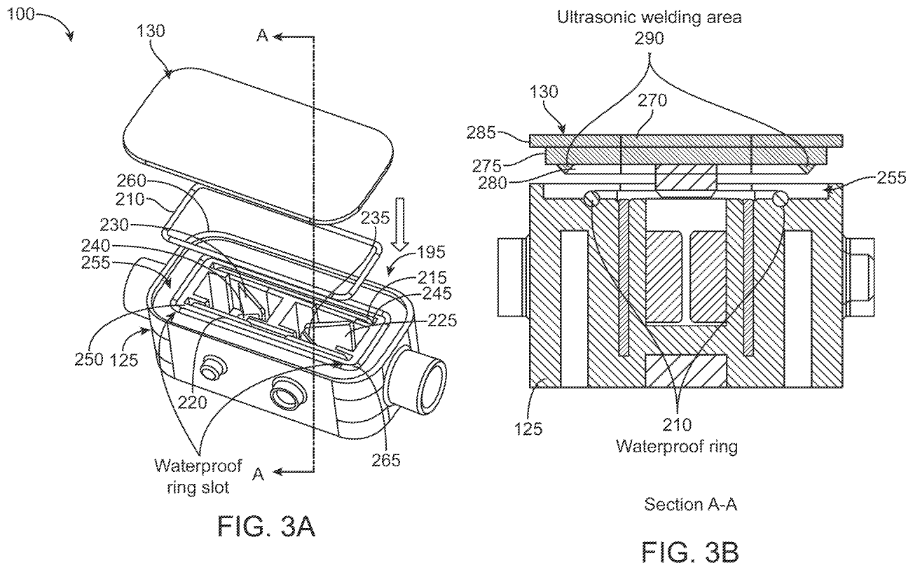

In some embodiments, a bottom wall 190 of the base portion 125 may have one or more features such as grooves, channels, slots, etc. that may be formed during the manufacturing process (e.g., during the molding process) and/or may be formed to assist during the assembly process of the electrical connector 100. The features that are shown in FIG. 2B on the bottom wall 190 may vary from one embodiment to another. The bottom wall 190 extends between the first end 145 and the second end 155 opposite a side 195 (see FIG. 2C) where the cover portion 130 is disposed. Referring specifically to FIG. 2C, the side 195 of the base portion 125 may define an opening into which the cover portion 130 may be received. The interlocking of the cover portion 130 with the base portion 125 is discussed in greater detail in FIGS. 3A and 3B below.

The electrical connector 100 also includes a first seal member 200 and a second seal member 205 configured to be disposed within the openings formed by the first projection 140 and the second projection 150, respectively. The first seal member 200 and the second seal member 205 may be configured to provide a snug fit to the first wire 105 and the second wire 110 when those wires are inserted within the openings of the first projection 140 and the second projection 150, respectively. In some embodiments, and as discussed further below, either or both of the first seal member 200 and the second seal member 205 may be provided with one or more ribs on an internal surface thereof (e.g., the surface in contact with or facing the wires) to further prevent the wires from being dislodged from the openings of the first projection 140 and the second projection 150. In some embodiments, the first seal member 200 and the second seal member 205 may each be composed of rubber or other suitable non-conductive material. In addition to the first seal member 200 and the second seal member 205, the electrical connector also includes a third seal member 210. In some embodiments, the third seal member 210 may be an O-ring configured to be disposed in the opening on the side 195 between the base portion 125 and the cover portion 130 to provide a snug fit between the cover portion and the base portion, as well as to interlock the cover portion with the base portion. Additional details of how the third seal member 210 may be secured to the base portion 125 are discussed in FIGS. 3A and 3B below.

Additionally, the electrical connector 100 includes a first contact 215 and a second contact 220 configured to be disposed within the volume 135 of the base portion 125. In some embodiments, each of the first contact 215 and the second contact 220 may be a “single element” conductive portion formed from a single conductive element (e.g., a single metal stamped sheet) having a gauge and other physical characteristics suitable for the application in which the electrical connector 100 is to be used. In some embodiments, each of the first contact 215 and the second contact 220 may be formed by deforming, bending, cutting, or otherwise folding a single piece of conductive material to form contact tines configured to receive the first wire 105 and the second wire 110. Although the housing 115 has been shown as including two contacts (e.g., the first contact 215 and the second contact 220), in other embodiments, the housing may house any number of contacts, including a single contact, enabling any number of electrical connections (e.g., two, four, six, etc.) to be formed between any number of wires. Further, in some embodiments, insulative material may be disposed within the volume 135 between the first contact 215 and the walls of the housing 115, as well as between the second contact 220 and the walls of the housing. Any additional components or elements that are desired or considered suitable to be disposed within the housing 115 may be inserted within the volume 135.

Referring still to FIG. 2C, each of the first contact 215 and the second contact 220 may include a single conductive strip on which cutouts are formed. For example, in some embodiments, each of the first contact 215 and the second contact 220 may define two cutouts, with each cutout forming a contact tine. Thus, the first contact 215 may define cutouts that form a first contact tine 225 and a second contact tine 230, while the second contact 220 may define cutouts that form a first contact tine 235 and a second contact tine 240. The shapes and sizes of each of the first contact tines 225, 235 and the second contact tines 230, 240 may vary in other embodiments from that shown in FIG. 2C. Also, although two contact tines are shown on each of the first contact 215 and the second contact 220, in other embodiments, each of those contacts may have greater than two contact tines. When inserted into the base portion 125, the first contact 215 may be configured to face the second contact 220. Accordingly, the first contact tines 225, 235 may face each other upon insertion into the base portion 125 and the second contact tines 230, 240 may face each other upon insertion into the base portion. Thus, for example, the first contact tine 225 of the first contact 215 may be aligned with and biased towards (e.g., bent or angled towards) the first contact tine 235 of the second contact 220 when the first contact and the second contact are inserted within the volume 135 of the base portion 125. Similarly, the second contact tine 230 of the first contact 215 may be aligned with and biased towards (e.g., bent or angled towards) the second contact tine 240 of the second contact 220 when the first contact and the second contact are inserted within the volume 135 of the base portion 125.

By biasing the first contact tines 225, 235 towards each other (e.g., face each other), those contact tines are configured to receive and engage the core or strands of the first wire 105 as the first wire is inserted through the opening of the first projection 140. In some embodiments, the first contact tines 225, 235 may define a pinch point or narrow space therebetween to provide a clamping mechanism to prevent inadvertent removal or unnecessary movement of the first wire 105 upon insertion. Similarly, by biasing the second contact tines 230, 240 towards each other, those contact tines are configured to receive and engage the core or strands of the second wire 110 as the second wire is inserted through the opening of the second projection 150. In some embodiments, the second contact tines 230, 240 may define a pinch point or narrow space therebetween to provide a clamping mechanism to prevent inadvertent removal or unnecessary movement of the second wire 110 upon insertion.

Thus, the electrical connector 100 includes the housing 115 having the base portion 125 defining the volume 135 into which the first contact 215 and the second contact 220 are disposed. The first contact 215 and the second contact 220 each defines contact tines that receive the first wire 105 and the second wire 110 for electrically connecting those wires. The cover portion 130 is disposed over the base portion 125 to provide a sealable connection.

Referring to FIGS. 3A and 3B, a partially exploded view of the electrical connector 100 is shown in FIG. 3A and a cross-sectional view taken along line A-A of FIG. 3A is shown in FIG. 3B. FIGS. 3A and 3B illustrate how the cover portion 130 may be connected to the base portion 125. Referring specifically to FIG. 3A, the base portion 125 is shown with the first contact 215 and the second contact 220 assembled within the volume 135 of the base portion. Upon assembling, the first contact tine 225 and the second contact tine 230 of the first contact 215 may be biased towards the interior of the volume 135 and towards the first contact tine 235 and the second contact tine 240, respectively, of the second contact 220. Similarly, upon assembling, the first contact tine 235 and the second contact tine 240 of the second contact 220 may be biased towards the first contact tine 225 and the second contact tine 230, respectively, of the first contact 215 and towards the interior of the volume 135. In some embodiments, the base portion 125 may include channels 245 and 250 adjacent an inner surface of the side walls 170 and 175 within which the first contact 215 and the second contact 220 may be inserted with the first contact tines 225, 235 and the second contact tines 230, 240 extending out of the respective channels. Thus, the channels 245, 250 may hold the first contact 215 and the second contact 220 in position within the volume 135 of the base portion 125.

The side 195 of the base portion 125 may also include a platform 255 that is somewhat recessed from an outer edge 260 of the base portion. The platform 255 may include a raised section 265 defined around the periphery of the platform 255 adjacent the channels 245, 250. The raised section 265 may define a ring slot between the raised section 265 and the channels 245, 250 for receiving the third seal member 210. The portion of the platform 255 that is between the raised section 265 and the outer edge 260 may be configured to receive a bottom surface of the cover portion 130, as shown in FIG. 3B. Specifically, in some embodiments, the bottom surface of the cover portion 130 may include a stepped profile. For example and as shown in FIG. 3B, the cover portion 130 may include an outer cover 270, a first stepped portion 275 that is smaller than the outer cover, and a second stepped portion 280 that is smaller than the first stepped portion. In other embodiments, the cover portion 130 may include either the first stepped portion 275 or the second stepped portion 280, while in yet other embodiments, the cover portion may include greater than two stepped portions.

In some embodiments, the cover portion 130, and particularly, the outer cover 270 may be sized such that an edge 285 of the outer cover rests on the outer edge 260 of the base portion 125 upon assembling. Further, in some embodiments, upon assembling, the first stepped portion 275 and the second stepped portion 280 may rest on the region of the platform 255 of the base portion 125 that is between the raised section 265 and the outer edge 260. In some embodiments, the second stepped portion 280 may be positioned to abut or contact the raised section 265 and/or the third seal member 210. In some embodiments, to secure the cover portion 130 to the base portion 125, the cover portion may be welded to the base portion. For example, in some embodiments, welding areas 290 on the second stepped portion 280 may be defined where the cover portion 130 may be welded to the base portion 125. In some embodiments, the welding areas 290 may weld the cover portion 130 to the third seal member 210. In some embodiments, ultrasonic welding may be used to weld the cover portion 130 to the base portion 125. In other embodiments, other types of welding or other securing mechanisms to secure the cover portion 130 to the base portion 125 may be used. By welding the cover portion 130 to the base portion 125, and by using the third seal member 210 in the ring slot defined by the raised section 265, the cover portion may be connected to the base portion in a waterproof manner. Thus, the electrical connector 100 may be considered waterproof, preventing seepage of water within the volume 135.

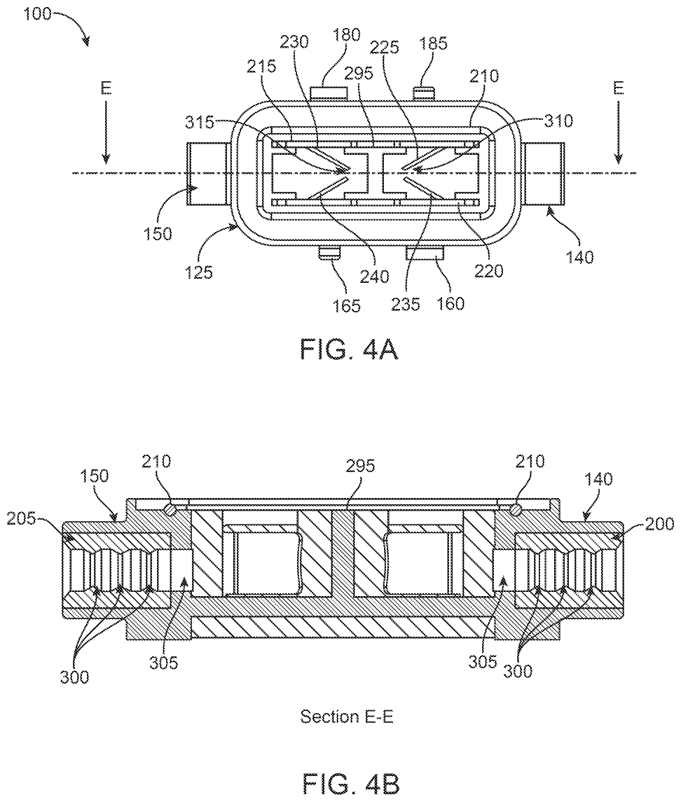

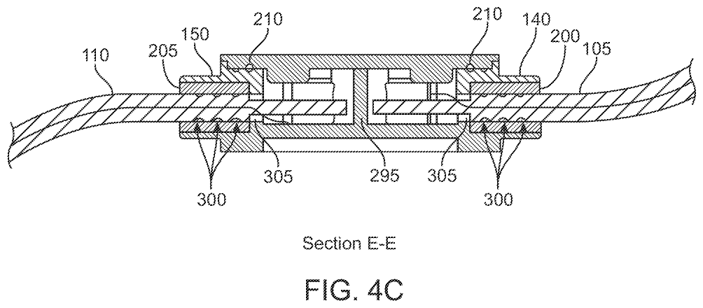

Turning to FIGS. 4A-4C, additional views of the electrical connector 100 are shown, in accordance with some embodiments of the present disclosure. Specifically, FIG. 4A shows a top view of the electrical connector 100 with the cover portion 130 removed. Thus, FIG. 4A shows the top view of the base portion 125 with the first contact 215 and the second contact 220 installed therein. FIG. 4B shows a cross sectional view along lines E-E of FIG. 4A with the first wire 105 and the second wire 110 removed. FIG. 4C also shows a cross-sectional view along lines E-E of FIG. 4A but with the first wire 105 and the second wire 110 inserted within the electrical connector 100. In addition to the elements described above, in some embodiments, the base portion 125 may include a wire stop 295 disposed within the volume 135. The wire stop 295 may provide a surface against which the conductive core or strands of the first wire 105 and the second wire 110 may abut against in the completely inserted position of the wires. The wire stop 295 prevents the first wire 105 and the second wire 110 from coming into contact with each other upon insertion. The wire stop 295 may assume various configurations as desired. For example, as shown in FIG. 4A, in some embodiments, the wire stop 295 may assume a substantially “I” shaped configuration extending between the channels 245 and 250. In other embodiments, the wire stop 295 may assume other configurations. In some embodiments, the wire stop 295 may be conductive in nature. In other embodiments, the wire stop 295 may be formed from an insulative material. In some embodiments, the wire stop 295 may be formed from the single metal sheet from which the first contact 215 and the second contact 220 are defined. In other words, in some embodiments, the wire stop 295 may be integrally formed with either the first contact 215 and/or the second contact 220. In some embodiments, a single wire stop may be provided, while in other embodiments, multiple wire stops may be provided. FIG. 4A also shows the biasing of the first contact tine 225 towards the first contact tine 235, and biasing of the second contact tine 230 towards the second contact tine 240, as discussed above.

Further, and referring to FIG. 4B now, as discussed above, the openings of the first projection 140 and the second projection 150 may have the first seal member 200 and the second seal member 205, respectively, inserted therein. FIG. 4B shows the first seal member 200 and the second seal member 205 in greater detail. In some embodiments, each of the first seal member 200 and the second seal member 205 may define one or more ribs on an interior surface (e.g., the surface that comes into contact with or faces the first wire 105 and the second wire 110 when those wires are inserted within the openings of the first projection 140 and the second projection 150) thereof. For example, in some embodiments, each of the first seal member 200 and the second seal member 205 may define three ribs 300 on the interior surface thereof. In other embodiments, the first seal member 200 and/or the second seal member 205 may define greater than or fewer than three ribs. The ribs 300 may provide a snug fit to the first wire 105 and the second wire 110 when those wires are inserted within the electrical connector 100, preventing any debris or water from entering the electrical connector, as well as preventing those wires from inadvertent removal from the electrical connector. In some embodiments, each of the first projection 140 and the second projection 150 may have an inner opening 305 around which the first seal member 200 and the second seal member 205, respectively, may be disposed. The inner opening 305 may be sized and shaped to receive the first wire 105 and the second wire 110.

FIG. 4C shows the first wire 105 and the second wire 110 inserted within the electrical connector 100. In some embodiments, the first projection 140 and the second projection 150 may be configured such that only the conductive core or strands of the first wire 105 and the second wire 110 extend beyond the inner openings 305. In other embodiments, a portion of the outer insulative layer 120 of the first wire 105 and the second wire 110 may also extend beyond the inner openings 305 into the volume 135 of the base portion 125. Thus, to electrically connect the first wire 105 with the second wire 110, the conductive core or strands of the first wire 105 may be inserted within the opening defined by the first projection 140 and the conductive core or strands of the second wire 110 may be inserted into the opening defined by the second projection 150. The first seal member 200 and the second seal member 205 may respectively guide the first wire 105 and the second wire 110 through the respective one of the first projection 140 and the second projection 150 and through the inner openings 305. As the first wire 105 and the second wire 110 are continued to be pushed or inserted into the electrical connector 100, the first wire 105 may extend through a space 310 (see FIG. 4A) defined between the first contact tine 225 and the first contact tine 235 and the second wire 110 may extend through a space 315 defined between the second contact tine 230 and the second contact tine 240. In some embodiments, the first wire 105 and the second wire 110 may continue to be inserted until each of those wires hit the wire stop 295.

When the first wire 105 and the second wire 110 are fully inserted into the electrical connector 100 (e.g., hit the wire stop 295 or are secured through the spaces 310 and 315), the first wire 105 and the second wire 110 may be electrically connected with one another by virtue of contacting the first contact tines 225, 235 and the second contact tines 230, 240, which are formed of conductive material. Specifically, the first wire 105 may be electrically connected to the second wire 110 through a conductive path extending between the conductive core or strands of the first wire 105 to the first contact tine 225, from the first contact tine 225 to the second contact tine 230, from the second contact tine 230 to the conductive core or strands of the second wire 110. Similarly, a conductive path may extend between the conductive core or strands of the first wire 105 to the first contact tine 235, from the first contact tine 235 to the second contact tine 240, and from the second contact tine 240 to the conductive core or strands of the second wire 110.

Referring to FIG. 5, an example diagram illustrating how the electrical connector 100 may be connected to other electrical connectors 320A, 320B is shown, in accordance with some embodiments of the present disclosure. As discussed above, the electrical connector 100 includes the receiving portions 160 and 180, and the pegs 165 and 185 for attaching the electrical connector to other electrical connectors. The receiving portion 160 and the peg 165 are defined on the side wall 170 of the electrical connector, while the receiving portion 180 and the peg 185 are defined on the side wall 175. The receiving portions 160 and 180 are larger in size than the pegs 165 and 185. Further, the spacing between the receiving portion 160 and the peg 165 on the side wall 170 is same as (or substantially similar to) the spacing between the receiving portion 180 and the peg 185 on the side wall 175. Further, the receiving portion 160 and the peg 165 are positioned on the side wall 170 such that the receiving portion 160 aligns with the peg 185 on the side wall 175 (e.g., the receiving portion and the peg share a center of axis along a line 325), and the peg 165 on the side wall 170 aligns with the receiving portion 180 on the side wall 175 (e.g., the receiving portion and the peg share a center of axis along a line 330). Thus, the receiving portions 160, 180 on one side wall align with the peg 185, 165, respectively, on the opposite side wall. In other words, the positioning of the receiving portion 160 and the peg 165 on the side wall 170 is inverted compared to the positioning of the receiving portion 180 and the peg 185 on the side wall 175. By virtue of alternating or inverting the positioning of the receiving portions and the pegs on the side walls, the receiving portions on each side wall may be configured to receive the pegs on the side wall of another electrical connector.

For example, a side wall 335 of the electrical connector 320A may have a receiving portion 340 and a peg 345 that are oriented similar to the receiving portion 180 and the peg 185, respectively, of the electrical connector 100. Thus, to connect the electrical connector 100 with the electrical connector 320A, the receiving portion 160 of the electrical connector 100 may receive the peg 345 of the electrical connector 320A, and the peg 165 of the electrical connector 100 may be received within the receiving portion 340 of the electrical connector 320A. As discussed above, the receiving portions (e.g., the receiving portions 160, 180, 340) may be defined with openings within which the pegs (e.g., the pegs 165, 185, 345) may be received. Thus, to join the receiving portions with the pegs, the pegs may simply be pushed (e.g., inserted) into the openings of the corresponding receiving portion. The electrical connector 320A may similarly be connected with the electrical connector 320B. Thus, the receiving portions and pegs (e.g., the receiving portions 160, 180, 340 and the pegs 165, 185, 345) may be used to mechanically connect an electrical connector with another electrical connector. To separate two connected electrical connectors, those electrical connectors may be pulled apart from one another releasing the pegs (e.g., the pegs 165, 185, 345) from the openings of the receiving portions (e.g., the receiving portions 160, 180, 340). Thus, the receiving portions and pegs provide an easy and simple mechanism to removably connect multiple electrical connectors together. Thus, the electrical connector 100 may be considered modular in configuration such that multiple electrical connectors may be connected together as desired.

By providing the ability to removably connect multiple electrical connectors using receiving portions and pegs, multiple electrical connectors may be positioned as close to each other as possible to achieve a minimum and/or consistent spacing between two electrical connectors. Such serial connection of multiple electrical connectors may also be beneficial for keeping each of the electrical connectors in position without needing any additional mechanisms to enable each electrical connector in a series of electrical connectors to maintain a desirable orientation and alignment. Although three electrical connectors (e.g., the electrical connector 100, 320A, 320B) are shown connected in FIG. 5, it is to be understood that the number of electrical connectors that may be connected as discussed in FIG. 5 above may be greater than or less than three. Further, although receiving portions and pegs have been used for facilitating the connection between two electrical connectors, in other embodiments, other removable mechanisms that allow two electrical connectors to be removably connected may be used.

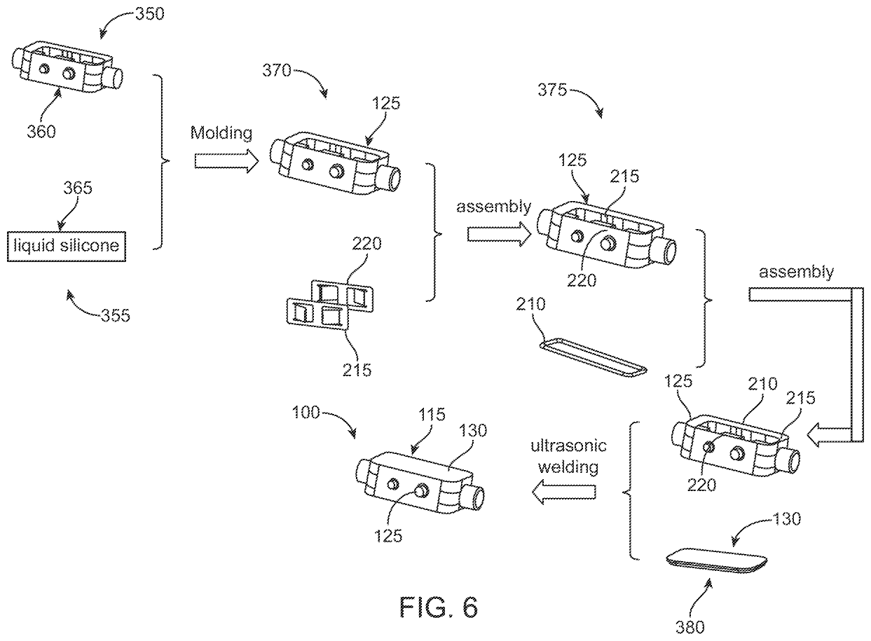

Referring to FIG. 6, an example flowchart outlining operations of a process 350 is shown, in accordance with some embodiments of the present disclosure. The process 350 may be used to manufacture and assemble the electrical connector 100. The process 350 may be used to manufacture the electrical connector 100 using traditional manufacturing techniques or by using 3D printing. Thus, at operation 355, a mold 360 of the base portion 125 of the housing 115 may be created. The mold 360 may be created to define the features of the base portion 125. In some embodiments, the mold 360 of the base portion 125 may be created from a plastic or other suitable material. Although not shown, a mold may also be created for the cover portion 130 of the housing 115. In some embodiments, the mold 360, upon creation, may be used for manufacturing multiple base portions. Thus, in some embodiments, the mold 360 may only need to be created once. In other embodiments, the mold 360 may need to be created each time a new base portion is to be manufactured. Further, in some embodiments, liquid silicone 365 may be used to create the body of the base portion 125. Thus, once the mold 360 is created, the liquid silicone 365 may be poured into the mold and cured. Once cured, the cured silicone may be removed from the mold 360 to obtain the base portion 125.

The cover portion 130 may be similarly manufactured. Further, upon manufacturing the base portion 125, the first seal member 200 and the second seal member 205 may be inserted into the first projection 140 and the second projection 150, respectively. In some embodiments, the first seal member 200 and the second seal member 205 may also be made of silicone or rubber or other suitable material. Operation 370 shows the base portion 125 with the first seal member 200 and the second seal member 205 assembled therein. The first contact 215 and the second contact 220 may be assembled within the base portion 125 at the operation 370. In some embodiments, each of the first contact 215 and the second contact 220 may be formed with a single conductive material. For example, a single metal sheet may be used to create the first contact 215 and another single metal sheet may be used to create the second contact 220. In other embodiments, other types of conductive material may be used. The metal sheet may be molded, bent, cut, or otherwise deformed to form each of the first contact 215 and the second contact 220. One or more contact tines may be formed on the metal sheet to form the first contact 215 and the second contact 220.

To form a contact tine, a cutout may be defined in the metal sheet of a desired shape and size. Although the cutout is shown as being rectangular in shape in the figures, the cutout may assume any desired shape. Further, as shown, the cutout is created such that the portion of the metal sheet being cut out is not completely severed from the metal sheet. For example, when the cutout is rectangular in shape, the metal sheet may be cut on three sides of the rectangle to form a contact tine. The cut out metal sheet may then be deformed and bent such that it faces a contact tine of another contact when installed within the volume 135 of the base portion 125. Upon forming each of the first contact 215 and the second contact 220, those contacts may be assembled within the base portion 125 at the operation 370. To assemble the first contact 215 and the second contact 220 within the base portion 125, the first contact may be inserted into the channel 245 such that the first contact tine 225 and the second contact tine 230 of the first contact are bent and biased towards the channel 250. Similarly, the second contact 220 may be inserted within the channel 250 such that the first contact tine 235 and the second contact tine 240 of the second contact is bent and biased towards the channel 245. Thus, the first contact tine 225 of the first contact 215 faces the first contact tine 235 of the second contact 220 upon assembling, and the second contact tine 230 of the first contact faces the second contact tine 240 of the second contact upon assembling. Thus, the first contact 215 and the second contact 220 upon assembling are configured to face each other defining the spaces 310 and 315 into which the first wire 105 and the second wire 110 may be inserted, as discussed above.

The base portion 125 with the first contact 215 and the second contact 220 assembled therein is then further assembled at operation 375 where the third seal member 210 is assembled over the base portion. Specifically the base portion 125 defines the platform 255 having the raised section 265 defining a ring slot into which the third seal member 210 may be friction fit. In some embodiments, the third seal member 210 may be assembled over the raised section 265 or at another location to provide a water tight seal between the cover portion 130 and the base portion 125 when the cover portion is assembled over the base portion. Upon assembling the third seal member 210 over the base portion 125, at operation 380, the cover portion 130 may be assembled over the base portion. In some embodiments, the cover portion 130 may be welded to the base portion 125, as discussed above. Upon welding the cover portion 130 to the base portion 125, the electrical connector 100, including the base portion 125 having the first contact 215, the second contact 220, the first seal member 200, the second seal member 205, the third seal member 210, and the cover portion 130 installed therein, may be considered assembled and ready for use. To use the electrical connector 100, the first wire 105 and the second wire 110 may be inserted into the housing 115, as discussed above.

When 3D printing is used to manufacture/assemble the electrical connector 100, the process 350 may be used with some variations. For example, in some embodiments, the first seal member 200, the second seal member 205, and the third seal member 210 may be integrally formed with the base portion during the operation 355. Further, in some embodiments, the first contact 215 and the second contact 220 may be 3D printed.

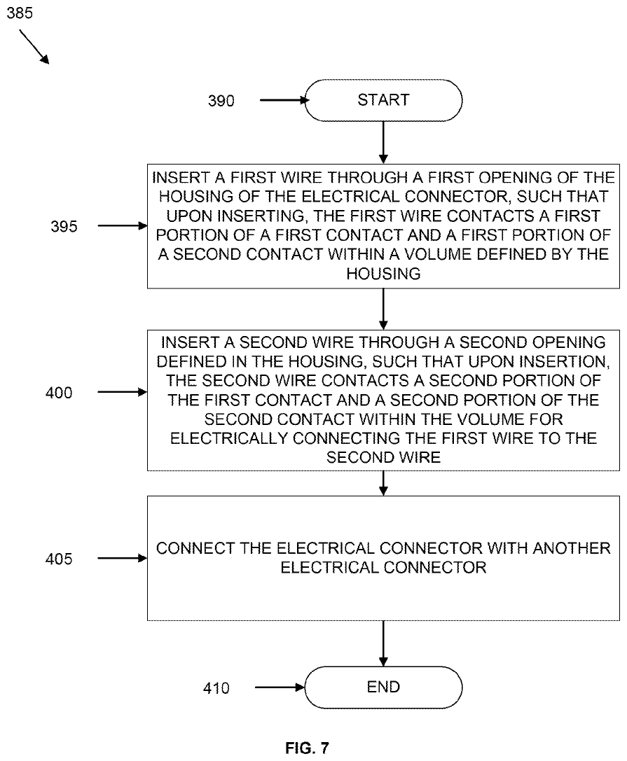

Turning to FIG. 7, an example flowchart outlining operations of a process 385 is shown, in accordance with some embodiments of the present disclosure. The process 385 describes a method of using the electrical connector 100. Thus, to use the electrical connector 100, upon starting at operation 390, the first wire 105 is inserted into the opening (e.g., first opening) defined in the first projection 140 of the base portion 125 of the housing 115 at operation 395. The first wire 105 is inserted into the volume 135 defined within the base portion 125 until the first wire passes through the space 310 defined between the first contact 215 and the second contact 220. In some embodiments, the first wire 105 may continue to be inserted into the volume 135 until the first wire hits the wire stop 295. At operation 400, the second wire 110 is inserted into the opening (e.g., second opening) defined in the second projection 150 of the base portion 125 of the housing 115. The second wire 110 is inserted into the volume 135 defined within the base portion 125 until the second wire passes through the space 315 defined between the first contact 215 and the second contact 220. In some embodiments, the second wire 110 may continue to be inserted into the volume 135 until the second wire hits the wire stop 295. By inserting the first wire 105 and the second wire 110 into the housing 115 such that each of the first wire and the second wire make contact with portions of the first contact 215 and the second contact 220, the first wire may be electrically connected to the second wire.

Further, the electrical connector 100 is mechanically and removably connected to another electrical connector (e.g., the electrical connector 320A) at operation 405. To connect the electrical connector 100 with another electrical connector (e.g., the electrical connector 320A), the electrical connector 100 may include the receiving portion 165 and the peg 160, while the electrical connector 320A may include the receiving portion 340 and the peg 345. The receiving portion 160 may receive the peg 345 and the receiving portion 340 may receive the peg 165 to connect the electrical connector 100 with the electrical connector 320A. Each of the electrical connectors 100 and 320A may be further connected to additional electrical connectors, as desired, in a similar way. The process 385 ends at operation 410.

Thus, the contact of the present disclosure provides a mechanism to easily and reliably electrically and mechanically connect one wire to one or more other wires.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An electrical connector comprising:
a housing comprising a first opening to receive a first wire and a second opening to receive a second wire;
a first contact within a volume of the housing to electrically connect the first wire to the second wire, wherein the first contact comprises a first contact tine and a second contact tine; and
a second contact within the volume of the housing to electrically connect the first wire to the second wire, wherein the second contact comprises a third contact tine and a fourth contact tine,
wherein the first contact tine is biased towards the third contact tine to receive the first wire and the second contact tine is biased towards the fourth contact tine to receive the second wire.

2. The electrical connector of claim 1, wherein the housing comprises a base portion and a cover portion interlocked with the base portion.

3. The electrical connector of claim 2, wherein the cover portion is welded to the base portion.

4. The electrical connector of claim 2, further comprising a seal member between the base portion and the cover portion.

5. The electrical connector of claim 1, wherein each of the first contact and the second contact is formed from a single sheet of a conductive material.

6. The electrical connector of claim 1, wherein the housing comprises a first projection within which the first opening is defined and a second projection within which the second opening is defined.

7. The electrical connector of claim 1, further comprising a first seal member within the first opening and a second seal member within the second opening.

8. The electrical connector of claim 7, wherein each of the first seal member and the second seal member comprises at least one rib on an inner surface thereof that faces the first wire and the second wire, respectively.

9. The electrical connector of claim 8, wherein the at least one rib on each of the first seal member and the second seal member comprises three ribs.

10. The electrical connector of claim 1, wherein the housing further comprises a receiving portion and a peg on a side wall of the housing, wherein the receiving portion and the peg are configured to removably connect the electrical connector to another electrical connector.

11. An electrical connector comprising:
a housing comprising a first opening to receive a first wire and a second opening to receive a second wire;
a contact within a volume defined by the housing to electrically connect the first wire to the second wire;
a first receiving portion on a first sidewall of the housing; and
a first peg on the first sidewall of the housing,
wherein the first receiving portion and the first peg are configured to removably connect the electrical connector to a second electrical connector.

12. The electrical connector of claim 11, further comprising a second receiving portion and a second peg on a second sidewall of the housing, wherein the second receiving portion and the second peg are configured to connect the electrical connector to a third electrical connector.

13. The electrical connector of claim 12, wherein the first receiving portion is larger in size than the first peg, and wherein the second receiving portion is larger in size than the second peg.

14. The electrical connector of claim 13, wherein the first receiving portion on the first sidewall is aligned with the second peg on the second sidewall, and wherein the first peg on the first sidewall is aligned with the second receiving portion on the second sidewall.

15. The electrical connector of claim 11, wherein the second electrical connector comprises a second receiving portion and a second peg, wherein the first receiving portion of the electrical connector is configured to receive the second peg of the second electrical connector, and wherein the second receiving portion of the second electrical connector is configured to receive the first peg of the electrical connector.

16. The electrical connector of claim 15, wherein the first receiving portion defines a third opening configured to receive the second peg, and wherein the second receiving portion defines a fourth opening configured to receive the first peg.

17. The electrical connector of claim 11, further comprising a cover portion interlocked with the base portion.

18. The electrical connector of claim 11, wherein the contact comprises a first contact and a second contact, wherein the first contact faces the second contact within the volume defined by the housing.

19. A method comprising:
inserting a first wire through a first opening defined in a housing of an electrical connector, wherein upon inserting, the first wire contacts a first portion of a first contact and a first portion of a second contact within a volume defined by the housing;
inserting a second wire through a second opening defined in the housing, wherein upon insertion, the second wire contacts a second portion of the first contact and a second portion of the second contact within the volume for electrically connecting the first wire to the second wire; and
connecting the electrical connector to a second electrical connector, wherein the electrical connector comprises a first receiving portion and a first peg on the housing of the electrical connector and the second electrical connector comprises a second receiving portion and a second peg on the housing of the second electrical connector, and connecting the electrical connector to the second electrical connector comprises receiving the first peg within the second receiving portion and receiving the second peg within the first receiving portion.

20. The method of claim 19, wherein inserting the first wire through the first opening comprises inserting the first wire through a first seal member positioned within the first opening, and wherein inserting the second wire through the second opening comprises inserting the second wire through a second seal member positioned within the second opening.
